(19) United States
(12) Patent Application Publication
(10) Pub. No.: US 2024/0326461 A1
(43) Pub. Date: Oct. 3, 2024

(54) PRINTING DEVICE AND PRINTING METHOD

(71) Applicant: SEIKO EPSON CORPORATION, Tokyo (JP)

(72) Inventors: Akito SATO, Matsumoto (JP); Masahiro MURATA, Shiojiri (JP); Kazuki TAKEUCHI, Matsumoto (JP)

(21) Appl. No.: 18/617,662

(22) Filed: Mar. 27, 2024

(30) Foreign Application Priority Data
Mar. 29, 2023 (JP) 2023-052977

(51) Int. Cl. B41J 2/21

(52) U.S. Cl. CPC B41J 2/2132

(57) ABSTRACT

A control section performs overlap printing in a second mode using black ink, which is achromatic. For example, when five continuous raster lines are formed, all of the five raster lines are formed by nozzles included in a downstream end nozzle group, nozzles included in an upstream end nozzle group, and nozzles included in an intermediate nozzle group. The control section performs overlap printing in a first mode using another ink that is a chromatic color. For example, when five continuous raster lines are formed, one raster line is formed by nozzles included in the downstream end nozzle group, nozzles included in the upstream end nozzle group, and nozzles included in the intermediate nozzle group, and the other four raster lines are formed by two nozzles included in the intermediate nozzle group.

The present application is based on, and claims priority from JP Application Serial Number 2023-052977, filed Mar. 29, 2023, the disclosure of which is hereby incorporated by reference herein in its entirety.

### BACKGROUND

### 1. Technical Field

The present disclosure relates to a printing device and a printing method.

### 2. Related Art

A printing device has been known that prints an image on a medium by alternately repeating a main scanning, in which a print head formed with nozzles ejects ink from the nozzles while scanning in a main scanning direction, and a sub-scanning, in which the medium is transported in a direction orthogonal to the main scanning direction. When a plurality of nozzles are formed in the print head along a direction intersecting the main scanning direction, a plurality of raster lines can be formed along the main scanning direction by one main scanning. In such a printing device, due to manufacturing errors of the nozzles or the like, a streak-like gap called banding may occur between some of the raster lines. Therefore, in order to make banding less conspicuous, it has been proposed to perform overlap printing in which one raster line is formed by a plurality of nozzles (for example, see JP-A-2002-11859). Generally, the more nozzles that are used to form one raster line, the less noticeable the banding.

However, when the number of nozzles for forming one raster line is increased, the density difference of the dots formed on the medium by the ejected ink may increase when the ink ejection position is slightly shifted. As a result, the graininess of the image deteriorates, and the image may appear rough. Also, depending on the color of the ink, the degradation of the graininess may become obvious or conspicuous in some cases.

### SUMMARY

A printing device for printing on a medium, includes a print head configured to form a plurality of dots on the medium by ejecting a first liquid and a second liquid, the print head including a first nozzle array in which a plurality of nozzles for ejecting the first liquid to the medium are arranged along a first direction and a second nozzle array in which a plurality of nozzles for ejecting the second liquid, which is different in color from the first liquid, to the medium are arranged along the first direction and a control section configured to execute printing by repeating main scanning in which the first liquid and the second liquid are ejected from the print head while a relative position of the print head with respect to the medium is changed in a second direction that intersects the first direction and sub-scanning in which the relative position of the print head with respect to the medium is changed by f dots along the first direction, f being a natural number, wherein the plurality of nozzles included in the first nozzle array are dividable into a first nozzle group including m nozzles located on one end side in the first direction, m being a natural number satisfying f≥m>1, a second nozzle group including m nozzles located on an other end side in the first direction, and a third nozzle group including a plurality of nozzles located in between the first nozzle group and the second nozzle group, the plurality of nozzles included in the second nozzle array are dividable into a fourth nozzle group including n nozzles located on the one end side in the first direction, wherein n is a natural number satisfying m>n≥1, a fifth nozzle group including n nozzles located on the other end side in the first direction, and a sixth nozzle group including a plurality of nozzles located in between the fourth nozzle group and the fifth nozzle group, and the control section is configured to when f consecutive raster lines are to be formed by the first liquid, form m raster lines by the nozzles included in the first nozzle group, by the nozzles included in the second nozzle group, and by the nozzles included in the third nozzle group, and form other f-m raster lines by two or more nozzles included in the third nozzle group and when f consecutive raster lines are to be formed by the second liquid, form n raster lines by the nozzles included in the fourth nozzle group, by the nozzles included in the fifth nozzle group, and by the nozzles included in the sixth nozzle group, and form other f-n raster lines by two or more nozzles included in the sixth nozzle group.

A printing method using a print head configured to form a plurality of dots on a medium by ejecting a first liquid and a second liquid, the print head including a first nozzle array in which a plurality of nozzles for ejecting a first liquid to a medium are arranged along a first direction and a second nozzle array in which a plurality of nozzles for ejecting the second liquid, which is different in color from the first liquid, to the medium are arranged along the first direction, the printing method including executing printing on the medium by repeating a main scanning of ejecting the first liquid and the second liquid from the print head while changing a relative position of the print head with respect to the medium along a second direction, which intersects the first direction, and a sub-scanning for changing a relative position of the print head with respect to the medium along the first direction by f dots, f being a natural number, the plurality of nozzles included in the first nozzle array are dividable into a first nozzle group including m nozzles located on one end side in the first direction, m being a natural number satisfying f≥m>1, a second nozzle group including m nozzles located on an other end side in the first direction, and a third nozzle group including a plurality of nozzles located in between the first nozzle group and the second nozzle group, the plurality of nozzles included in the second nozzle array are dividable into a fourth nozzle group including n nozzles located on the one end side in the first direction, wherein n is a natural number satisfying m>n≥1, a fifth nozzle group including n nozzles located on the other end side in the first direction, and a sixth nozzle group including a plurality of nozzles located in between the fourth nozzle group and the fifth nozzle group, when f consecutive raster lines are to be formed by the first liquid, forming m raster lines by the nozzles included in the first nozzle group, by the nozzles included in the second nozzle group, and by the nozzles included in the third nozzle group, and forming other f-m raster lines by two or more nozzles included in the third nozzle group, and when f consecutive raster lines are to be formed by the second liquid, forming n raster lines by the nozzles included in the fourth nozzle group, by the nozzles included in the fifth nozzle group, and by the nozzles included in the sixth nozzle group, and forming other f-n raster lines by two or more nozzles included in the sixth nozzle group.

### BRIEF DESCRIPTION OF THE DRAWINGS

FIG. 1 is a diagram schematically showing a configuration of a printing device.

FIG. 2 is a view showing the medium and the print head in a simplified manner as viewed from above.

FIG. 3A is a diagram showing a nozzle array in a first mode of overlap printing.

FIG. 3B shows nozzle locations and dots formed in passes 1 to 14 in the first mode of overlap printing.

FIG. 4A is a diagram showing a nozzle array in a second mode of overlap printing.

FIG. 4B shows nozzle locations and dots formed in passes 1 to 14 of the second mode of overlap printing.

FIG. 5A is a diagram showing positions of dots when ink ejection positions gradually shift in a main scanning direction during transport of the medium.

FIG. 5B is a diagram showing positions of dots when ink ejection positions gradually shift in the main scanning direction during transport of the medium.

FIG. 6A is a diagram showing positions of dots when ink ejection positions shift in both the main scanning direction and in the sub-scanning direction.

FIG. 6B is a diagram showing positions of dots when ink ejection positions shift in both the main scanning direction and the sub-scanning direction.

FIG. 7 is a flowchart showing a process executed by the control section according to a program.

### DESCRIPTION OF EMBODIMENT

Hereinafter, an embodiment of the present disclosure will be described with reference to the drawings. Note that each of the drawings is merely an example for explaining the present embodiment. Since the figures are illustrative, the proportions and shapes may not be precise, may not be consistent with one another, or may have portions omitted.

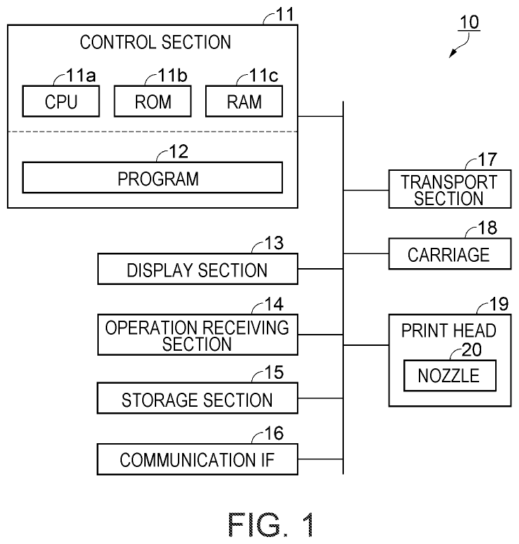

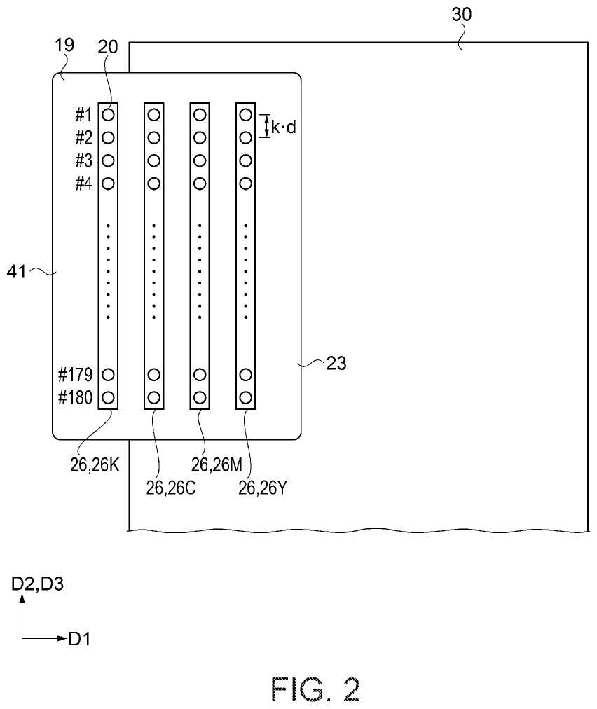

FIG. 1 is a diagram schematically showing the configuration of the printing device 10 according to the present embodiment. The printing device 10 prints an image by ejecting a liquid such as ink onto a medium 30 such as paper (see FIG. 2).

The printing device 10 includes a control section 11, a display section 13, an operation receiving section 14, a storage section 15, a communication IF 16, a transport section 17, a carriage 18, a print head 19, and the like. IF is an abbreviation for interface. The control section 11 is configured from one or a plurality of ICs having a CPU 11a as a processor, a ROM 11b, a RAM 11c, and the like, and from other memories.

The control section 11 controls the operation of the printing device 10 by the processor, that is, the CPU 11a, executing calculation processes in accordance with a program 12 stored in the ROM 11b or other memory or the like using the RAM 11c or the like as a work area. The processor is not limited to one CPU, but may be configured from a plurality of CPUs, or configured to perform processing by a hardware circuit such as an ASIC. Processing may be performed by a CPU and a hardware circuit in cooperation with each other.

The display section 13 is means for displaying visual information, and is constituted by, for example, a liquid crystal display, an organic EL display, or the like. The display section 13 may be configured to include a display and a drive circuit for driving the display.

The operation receiving section 14 is means for receiving an input by the user, and is realized by, for example, a physical button, a touch panel, a mouse, a keyboard, or the like. Of course, a touch panel may realize the function of the display section 13. The display section 13 and the operation receiving section 14 may be collectively referred to as an operation panel of the printing device 10.

The storage section 15 is, for example, a hard disk drive, a solid state drive, or other memory storage means. A part of the memory of the control section 11 may be regarded as the storage section 15. The storage section 15 may be regarded as a part of the control section 11. The display section 13, the operation receiving section 14, and the storage section 15 may be peripheral devices externally attached to the printing device 10.

The communication IF 16 is a generic name of one or a plurality of IFs that the printing device 10 uses to communicate with an external apparatus in a wired or wireless manner in accordance with a predetermined communication protocol. The external device is, for example, a communication device such as a personal computer, a server, a smartphone, or a tablet terminal.

The transport section 17 is means for transporting the medium 30 (see FIG. 2) along a predetermined sub-scanning direction D2 (see FIG. 2) under the control of the control section 11. The transport section 17 includes, for example, a roller that rotates to transport the medium 30, a motor as a power source of rotation, and the like. The transport section 17 may be a configuration that transports the medium 30 while the medium 30 is mounted on a pallet, a belt, a drum, or the like. The medium 30 is, for example, a paper, but may be any medium capable of being printed by a liquid, and may be a material other than paper, such as fabric or film.

The carriage 18 is a movement means that reciprocates along a main scanning direction D1 (see FIG. 2), which intersects the sub-scanning direction D2 under the control of the control section 11 by power of a carriage motor (not shown). The main scanning direction D1 is typically orthogonal to the sub-scanning direction D2. A print head 19 is mounted on the carriage 18. An operation of ejecting ink from the print head 19 based on print data while changing the relative position of the print head 19 with respect to the medium 30 along the main scanning direction D1 by movement of the carriage 18 is referred to as “main scanning” or “pass”. An N-th number pass is also referred to as “pass n”. The main scanning direction D1 corresponds to a second direction, and the sub-scanning direction D2 corresponds to a first direction.

An operation in which the transport section 17 transports the medium 30 by a predetermined distance in the sub-scanning direction D2 (see FIG. 2) between passes is referred to as “sub-scanning” or “paper feed”. That is, for each pass, the transport section 17 changes the relative position of the print head 19 with respect to the medium 30 by a predetermined movement amount along the sub-scanning direction D2. The control section 11 controls the print head 19, the carriage 18, and the transport section 17 in this manner, and repeats the main scanning and the sub-scanning alternately to execute printing of a two dimensional image on the medium 30.

The print head 19 has a plurality of nozzles 20 for ejecting liquid. The print head 19 forms a plurality of dots on the medium 30 by ejecting liquid from the nozzles 20 to the medium 30. In the following description, it is assumed that the liquid is ink, but the liquid ejected by the print head 19 may be a liquid other than ink.

The print head 19 ejects ink based on print data that is for printing an image and that was generated by the control section 11. As is known, the control section 11 controls application of a drive signal to a drive element (not shown) provided for each nozzle 20 in accordance with print data to eject or not eject ink from each of the nozzles 20, and by this, prints an image on the medium 30. The print head 19 is supplied with ink of each color from a liquid holding section (not shown) called an ink cartridge or an ink tank, and ejects the ink from the nozzles 20. For each color ink, the print head 19 has a nozzle array 26 in which a plurality of nozzles 20 are arranged. In this embodiment, the print head 19 is provided with four nozzle arrays 26, and each nozzle array 26 ejects ink of a different color. Specifically, the print head 19 is capable of ejecting cyan ink (C), magenta ink (M), yellow ink (Y), and black ink (K). Of course, the ink ejected by the print head 19 is not limited to CMYK.

FIG. 2 is a view showing the medium 30 and the print head 19 in a simplified manner as viewed from above, and shows the nozzle surface 23, which is the lower surface of the print head 19, through the nozzle surface 23. Of the four nozzle arrays 26, the nozzles 20 included in the nozzle array 26C eject cyan ink. The nozzles 20 included in the nozzle array 26M eject magenta ink, the nozzles 20 included in the nozzle array 26Y eject yellow ink, and the nozzles 20 included in the nozzle array 26K eject black ink. The print head 19 can form a plurality of dots of each color on the medium 30 by ejecting ink of each color onto the medium 30.

The direction in which the nozzles 20 constituting the nozzle array 26 are arranged is also referred to as a “nozzle arrangement direction D3”. In the example of FIG. 2, the nozzle arrangement direction D3 is parallel to the sub-scanning direction D2. Therefore, it can be said that the nozzles 20 constituting the nozzle array 26 are arranged along the sub-scanning direction D2. In such a configuration, the nozzle arrangement direction D3 is orthogonal to the main scanning direction D1. However, the nozzle arrangement direction D3 may not be parallel to the sub-scanning direction D2, but may be oblique to the sub-scanning direction D2. Whether or not the nozzle arrangement direction D3 is parallel to the sub-scanning direction D2, it can be said that the nozzle arrangement direction D3 intersects the main scanning direction D1, and that the nozzles 20 constituting the nozzle arrays 26 are arranged at a predetermined nozzle pitch in the sub-scanning direction D2. Therefore, in this embodiment, even if the nozzle arrangement direction D3 is oblique to the sub-scanning direction D2, it is interpreted that the plurality of nozzles 20 constituting the nozzle arrays 26 are arranged along the sub-scanning direction D2.

The print head 19 mounted on the carriage 18, together with the carriage 18 performs forward movement, which is movement from one end to the other end in the main scanning direction D1, and backward movement, which is movement from the other end to the one end. FIG. 2 shows an example of the arrangement of the nozzles 20 on the nozzle surface 23. The nozzle surface 23 is a lower surface of the print head 19 and a surface facing the medium 30. The individual small 1 circles in the nozzle surface 23 represent the individual nozzles 20.

In the example of FIG. 2, the nozzle arrays 26C, 26M, 26Y, and 26K are arranged along the main scanning direction D1. The nozzle arrays 26 for the respective colors are arranged at the same positions in the sub-scanning direction D2. The nozzles 20 of each of the nozzle arrays 26C, 26M, 26Y, and 26K are arranged in the sub-scanning direction D2 at a constant or substantially constant nozzle pitch. The nozzle pitch is the interval between the nozzles 20 in the sub-scanning direction D2.

The nozzle pitch is represented by k·d. Here, d is the minimum dot pitch in the sub-scanning direction D2. In other words, d is a distance between dots formed on the medium 30 at the maximum resolution. Further, k is a natural number of 1 or more. For example, when the nozzle pitch is 180 dpi ( 1/180 inch) and the dot pitch in the sub-scanning direction D2 is 360 dpi ( 1/360 inch), k=2.

In FIG. 2, each nozzle array 26 includes 180 of the nozzles 20. The nozzles 20 are numbered from #1 to #180 so that the number becomes smaller the further toward the downstream side in the sub-scanning direction D2, which is the transport direction of the medium 30. In other words, the #1 nozzle 20 is located downstream of the #180 nozzle 20 in the sub-scanning direction D2.

Note that the configuration of the printing device 10 shown in FIG. 1 may be realized by a single printer, or by a plurality of apparatuses communicatively connected to each other. That is, the printing device 10 may actually be a printing system. The printing system includes, for example, a printing control device that functions as the control section 11 and the storage section 15, and a printer having the transport section 17, the carriage 18, the print head 19, and the like. The printing method of the present embodiment is realized by the printing device 10 or the printing system.

Next, a printing method by the printing device 10 will be described.

In the case where one raster line extending in the main scanning direction D1 is formed on the medium 30 by one color of ink, in the present embodiment a raster line is formed in a plurality of passes, not by the ink being repeatedly ejected from only one of the nozzles 20 to form the raster line in a single pass. Specifically, in the first pass, ink is ejected intermittently from one of the nozzles 20, and in the second pass, ink is ejected to positions where ink was not ejected in the first pass, from a nozzle 20 different from the nozzle 20 used in the first pass. Such a printing method of forming a raster line through a plurality of passes using a plurality of different nozzles 20 is referred to as overlap printing. By performing overlap printing, banding caused by a manufacturing error of the nozzles 20 or the like can be made less conspicuous. Generally, the greater the number of nozzles 20 used to form one raster line, the less noticeable the banding. Overlap printing includes various modes such as a mode in which all the raster lines are formed by the same number of nozzles 20, a mode in which the number of nozzles 20 used to form some of the raster lines differs from the number of nozzles 20 used to form other raster lines, and the like.

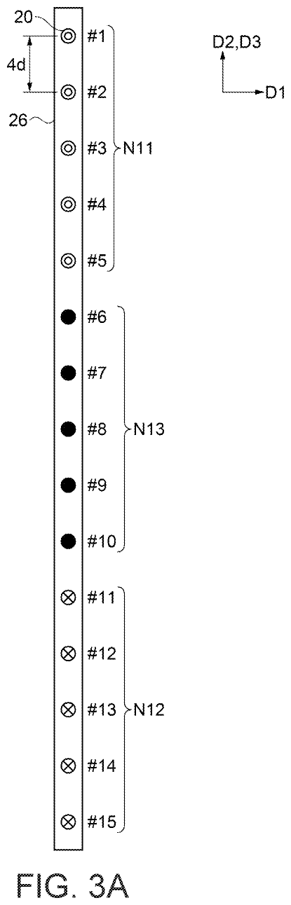

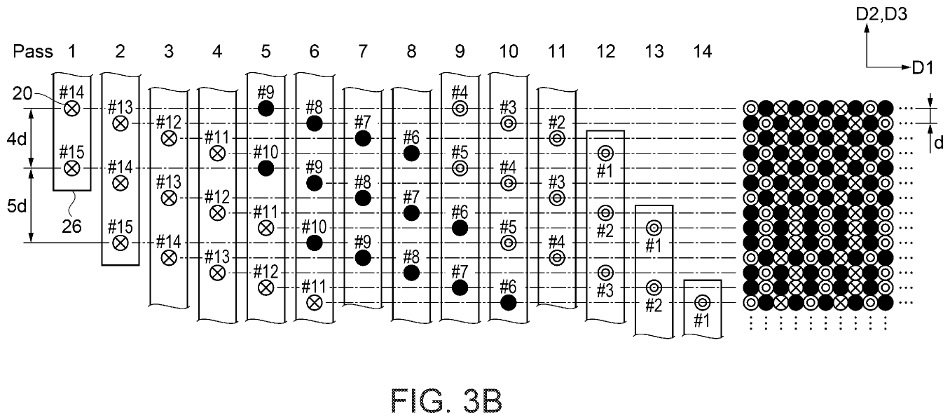

FIGS. 3A and 3B are diagrams for explaining a first mode of overlap printing, FIG. 3A shows the nozzle array 26, and FIG. 3B shows the positions of the nozzles 20 and the dots formed in passes 1 to 14.

For convenience of explanation, only one nozzle array 26 of the four nozzle arrays 26 is shown, and the number of nozzles 20 included in the one nozzle array 26 is set to 15, which is smaller than the actual number. In this example, the nozzle pitch is 4d. In FIG. 3B, the nozzle array 26 is depicted as moving relative to the medium 30, but this figure shows the relative position between the nozzle array 26 and the medium 30, and the medium 30 is actually moving in the sub-scanning direction D2. In this example, the amount of movement of the medium 30 in the sub-scanning for each pass is 5d. Although it is shown that each of the nozzles 20 forms only a few dots in the main scanning direction D1, actually, ink droplets are ejected intermittently from the nozzles 20 moving in the main scanning direction D1, so that a large number of dots are arranged in the main scanning direction D1. This row of dots is the raster line described above.

In FIG. 3A, among the fifteen nozzles 20, the five nozzles 20 positioned on the downstream end side, which is one end side in the sub-scanning direction D2, are indicated by double circle marks. These nozzles 20 constitute a downstream end nozzle group N11. That is, the downstream end nozzle group N11 in the first mode includes the five nozzles 20 of #1 to #5. The five nozzles 20 located on the upstream end side, which is the other end side in the sub-scanning direction D2, are indicated by encircled×marks. These nozzles 20 constitute an upstream end nozzle group N12. That is, the upstream end nozzle group N12 in the first mode includes the five nozzles 20 of #11 to #15. The five nozzles 20 located between the downstream end nozzle group N11 and the upstream end nozzle group N12 are indicated by black circle marks. These nozzles 20 constitute an intermediate nozzle group N13. That is, the intermediate nozzle group N13 in the first mode includes the five nozzles 20 of #6 to #10.

As described above, in the first mode, the nozzles 20 included in the nozzle array 26 can be divided into three nozzle groups, that is, the downstream end nozzle group N11, the upstream end nozzle group N12, and the intermediate nozzle group N13. The downstream end nozzle group N11 in the first mode corresponds to a first nozzle group, the upstream end nozzle group N12 in the first mode corresponds to a second nozzle group, and the intermediate nozzle group N13 in the first mode corresponds to a third nozzle group.

In FIG. 3B, the dots formed on the medium 30 are indicated by the same marks as the marks as used for the nozzles 20 so that it is possible to understand which dots are formed by nozzles 20 included in which nozzle group. That is, in FIG. 3B, the uppermost raster line is formed by three nozzles 20, that is, the #4 nozzle 20 included in the downstream end nozzle group N11, the #14 nozzle 20 included in the upstream end nozzle group N12, and the #9 nozzle 20 included in the intermediate nozzle group N13. Here, the #9 nozzle 20 included in the intermediate nozzle group N13 forms dots intermittently at a rate of once every two times, and the #4 nozzle 20 included in the downstream end nozzle group N11 and the #14 nozzle 20 included in the upstream end nozzle group N12 both form dots intermittently at a rate of once every four times.

The second raster line from the top is formed by three nozzles 20, that is, the #3 nozzle 20 included in the downstream end nozzle group N11, the #13 nozzle 20 included in the upstream end nozzle group N12, and the #8 nozzle 20 included in the intermediate nozzle group N13. The third raster line from the top is formed by three nozzles 20, that is, the #2 nozzle 20 included in the downstream end nozzle group N11, the #12 nozzle 20 included in the upstream end nozzle group N12, and the #7 nozzle 20 included in the intermediate nozzle group N13. The fourth raster line from the top is formed by three nozzles 20, that is, the #1 nozzle 20 included in the downstream end nozzle group N11, the #11 nozzle 20 included in the upstream end nozzle group N12, and the #6 nozzle 20 included in the intermediate nozzle group N13. The fifth raster line from the top is formed by three nozzles 20, that is, the #5 nozzle 20 included in the downstream end nozzle group N11, the #15 nozzle 20 included in the upstream end nozzle group N12, and the #10 nozzle 20 included in the intermediate nozzle group N13.

The sixth raster line from the top is formed by the same nozzles 20 as the uppermost raster line. That is, since the amount of movement of the medium 30 in the sub-scanning for each pass is 5d, the subsequent raster lines are formed by the same nozzles 20 as those that form the raster lines five passes above. In other words, when the amount of movement of the medium 30 in the sub-scanning for each pass is f·d, that is, when if is f dots worth of movement (f being a natural number), the configuration of the nozzles 20 for forming raster lines is repeated for each of f number of raster lines. Similarly to the uppermost raster line, for the other raster lines, the nozzles 20 included in the intermediate nozzle group N13 intermittently form dots at a rate of once every two times, and the nozzles 20 included in the downstream end nozzle group N11 and the upstream end nozzle group N12 both intermittently form dots at a rate of once every four times.

As described above, in the overlap printing of the first mode, five raster lines out of five continuous raster lines, that is, all the raster lines are formed by three nozzles belonging to different nozzle groups.

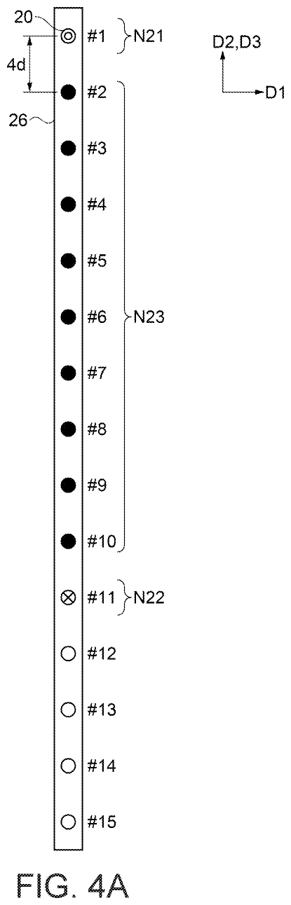

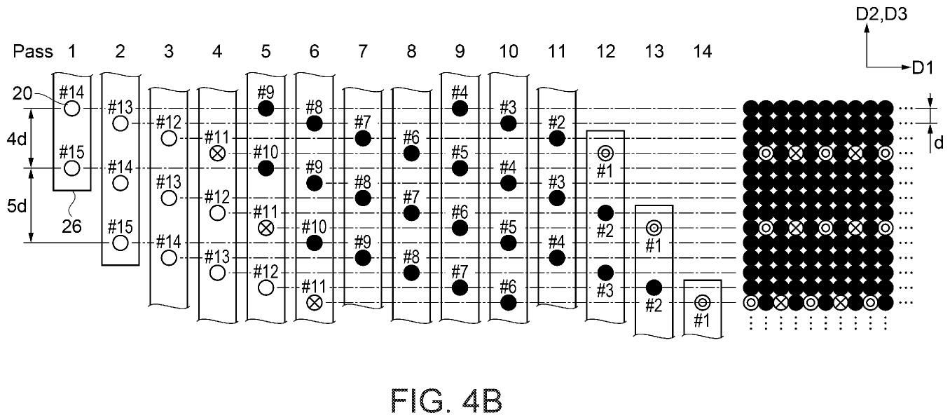

FIGS. 4A and 4B are illustrations for explaining overlap printing in the second mode, FIG. 4A shows the nozzle arrays 26, and FIG. 4B shows the positions of the nozzles 20 and the dots formed in passes 1 to 14. As in the first mode, the number of nozzles 20 included in one nozzle array 26 is 15. As in the first mode, the nozzle pitch is 4d, and the amount of movement of the medium 30 in the sub-scanning for each pass is 5d.

In FIG. 4A, of the fifteen nozzles 20, four nozzles 20 located on the upstream side in the sub-scanning direction D2 are indicated by white circle marks. These nozzles 20 are unused nozzles that do not eject ink. Therefore, in the second mode, the nozzle array 26 substantially includes 11 nozzles 20. Of the 11 nozzles 20 for ejecting ink, one nozzle 20 positioned on the downstream end side, which is one end side in the sub-scanning direction D2, is indicated by a double circle mark. The nozzle 20 constitutes a downstream end nozzle group N21. That is, the downstream end nozzle group N21 in the second mode includes the single #1 nozzle 20. Among the 11 nozzles 20, one nozzle 20 located on the upstream end side, which is the other end side in the sub-scanning direction D2, is indicated by an encircled×mark. This nozzle 20 constitutes an upstream end nozzle group N22. That is, the upstream end nozzle group N22 in the second mode includes one nozzle 20 of #11. The nine nozzles 20 located between the downstream end nozzle group N21 and the upstream end nozzle group N22 are indicated by black circle marks. These nozzles 20 constitute an intermediate nozzle group N23. That: is, the intermediate nozzle group N23 in the second mode includes the nine nozzles 20 of #2 to #10.

In this way, in the second mode, the nozzles 20 included in the nozzle array 26 can be divided into three nozzle groups, that is, the downstream end nozzle group N21, the upstream end nozzle group N22, and the intermediate nozzle group N23. The downstream end nozzle group N21 in the second mode corresponds to a fourth nozzle group, the upstream end nozzle group N22 in the second mode corresponds to a fifth nozzle group, and the intermediate nozzle group N23 in the second mode corresponds to a sixth nozzle group.

Also in FIG. 4B, the dots formed on the medium 30 are indicated by the same marks as the marks of the nozzles 20 so that it is possible to understand which dots are formed by the nozzles 20 included in which nozzle groups. That is, in FIG. 4B, the uppermost raster line is formed by two nozzles 20, that is, the #4 nozzle 20 included in the intermediate nozzle group N23 and the #9 nozzle 20 included in the intermediate nozzle group N23. Here, the #4 nozzle 20 and the #9 nozzle 20 both intermittently form dots at a rate of once every two times.

The second, third, and fifth raster lines from the top are also formed by two nozzles 20 included in the intermediate nozzle group N23. Specifically, the second raster line from the top is formed by the #3 nozzle 20 and the #8 nozzle 20, the third raster line from the top is formed by the #2 nozzle 20 and the #7 nozzle 20, and the fifth raster line from the top is formed by the #5 nozzle 20 and the #10 nozzle 20. As with the first raster line, for the second, third, and fifth raster lines, each two nozzles 20 form dots intermittently at a rate of once every two times.

On the other hand, the fourth raster line from the top is formed by three nozzles 20, that is, the #1 nozzle 20 included in the downstream end nozzle group N21, the #11 nozzle 20 included in the upstream end nozzle group N22, and the #6 nozzle 20 included in the intermediate nozzle group N23. The #6 nozzle 20 included in the intermediate nozzle group N23 forms dots intermittently at a rate of once every two times, and the #1 nozzle 20 included in the downstream end nozzle group N21 and the #11 nozzle 20 included in the upstream end nozzle group N22 both form dots intermittently at a rate of once every four times.

The sixth raster line from the top is formed by the same nozzles 20 as those for the uppermost raster line. That is, the configuration of nozzles 20 forming raster lines is repeated for every five raster lines because the movement amount of the medium 30 in the sub-scanning for each pass is 5d.

In this way, in overlap printing in the second mode, four raster lines out of five continuous raster lines are formed by two nozzles 20 included in the intermediate nozzle group N23. The other raster line is formed by three nozzles, each belonging to a different nozzle group.

A raster line formed by the nozzles 20 of three different nozzle groups, such as all the raster lines in the first mode and the fourth raster line from the top in the second mode, is defined as a “complementary raster line”. That is, in the first mode, all of the five raster lines among five continuous raster lines are complementary raster lines, and in the second mode, one raster line among five continuous raster lines is a complementary raster line. Complementary raster lines are formed using a larger number of nozzles 20 than the other raster lines, which are formed by two nozzles 20 included in one nozzle group.

In the first mode, when the number of nozzles 20 included in the downstream end nozzle group N11 is m (m being a natural number), the number of nozzles 20 included in the upstream end nozzle group N12 is also m, and m=5 in the present embodiment. In the first mode, the number of complementary raster lines included in five continuous raster lines is five, which is equal to m. On the other hand, the number of raster lines other than the complementary raster lines among the five continuous raster lines is 0. That is, assuming that the amount of movement of the medium 30 in the sub-scanning for each pass is f·d, the number of complementary raster lines included in the f number of continuous raster lines coincides with m, which is the number of nozzles 20 included in the downstream end nozzle group N11 or the upstream end nozzle group N12. Among the f number of continuous raster lines, the number of raster lines other than the complementary raster lines is f-m.

Similarly, in the second mode, assuming that the number of nozzles 20 included in the downstream end nozzle group N21 is n (n being a natural number), the number of nozzles 20 included in the upstream end nozzle group N22 is also n, and n=1 in this embodiment. In the second mode, the number of complementary raster lines included in the continuous five raster lines is 1, which is equal to n. On the other hand, the number of raster lines other than the complementary raster lines among the five continuous raster lines is 4. That is, assuming that the amount of movement of the medium 30 in the sub-scanning for each pass is f·d, the number of complementary raster lines included in the f number of continuous raster lines coincides with n, which is the number of nozzles 20 included in the downstream end nozzle group N21 or the upstream end nozzle group N22. Among the f number of continuous raster lines, the number of raster lines other than the complementary raster lines is f-n.

Assuming that the number of passes required for forming one raster line, that is, the number of nozzles 20 used for forming one raster line, is defined as the number of overlaps, in the first mode, the number of overlaps is three in all the raster lines. On the other hand, in the second mode, among the five continuous raster lines, the number of overlaps of the one raster line that is the complementary raster line is three, and the number of overlaps of the other four raster lines is two.

As described above, as the number of nozzles 20 forming a raster line increases, that is, as the number of raster lines formed by using a large number of nozzles 20 increases, the less conspicuous banding becomes. Therefore, in overlap printing in the first mode, in which all the raster lines are set as complementary raster lines, banding can be made less conspicuous as compared with the overlap printing in the second mode, in which one of five raster lines is set as a complementary raster line.

However, when the ink ejection position deviates from the original position due to the operating state of the printing device 10, errors in various parts, or the like, graininess of the dots may deteriorate as the number of nozzles 20 increases. Here, the state in which the graininess deteriorates is a state in which the density difference of dots becomes large and the image appears rough.

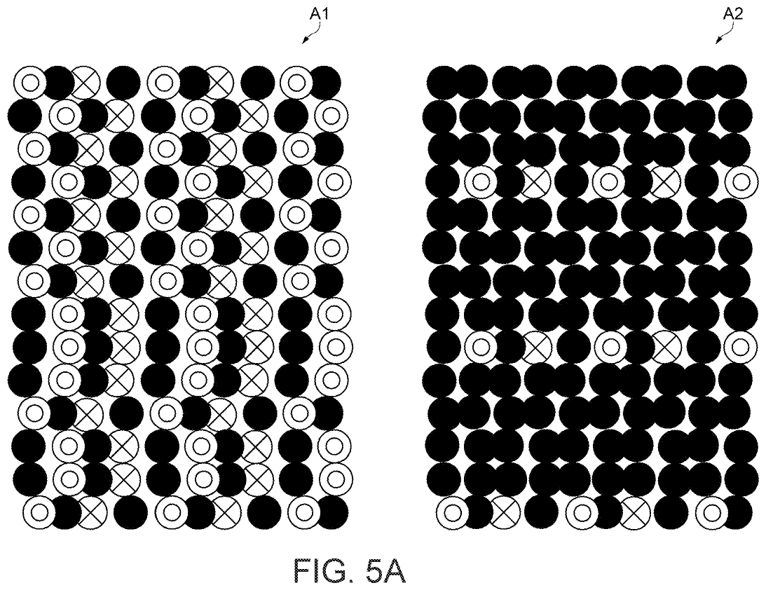

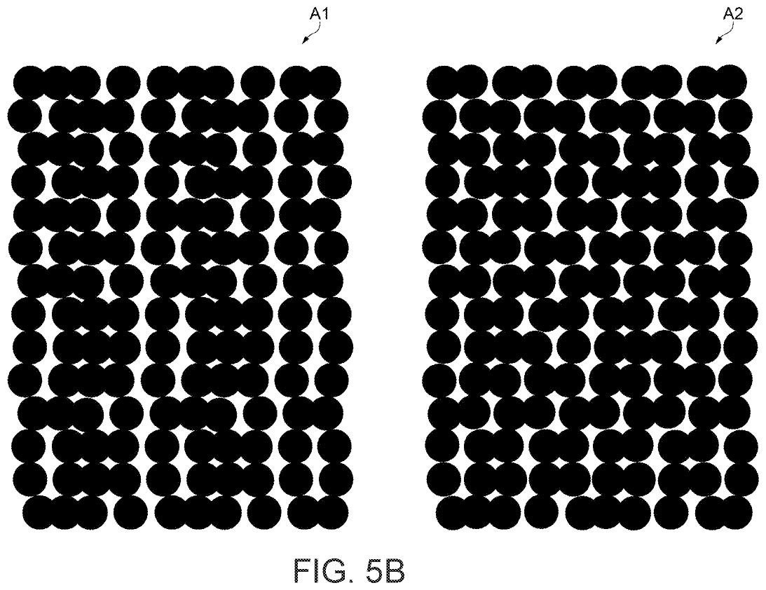

FIGS. 5A and 5B are diagrams showing the positions of dots when the ink ejection position is gradually shifted in the main scanning direction D1 in the process of transport of the medium 30, and the positions of the dots are obtained by simulation. Here, FIG. 5A is a diagram in which the dots are represented by the same marks as those in FIG. 3B and FIG. 4B, and FIG. 5B is a diagram in which all the dots are represented by black circle marks so that the difference in graininess can be easily understood. In both figures, the dot group indicated by A1 is a dot group formed when overlap printing in the first mode is executed, and the dot group indicated by A2 is a dot group formed when overlap printing in the second mode is executed. Such a deviation in the ejection position in the main scanning direction D1 may occur, for example, when among the plurality of transport rollers arranged side by side in the main scanning direction D1, the diameter of a transport roller on one side in the main scanning direction D1 is different from the diameter of a transport roller on the other side.

As shown in FIG. 5B, in overlap printing in the first mode, which has many complementary raster lines, graininess deteriorated more than compared with the overlap printing of the second mode.

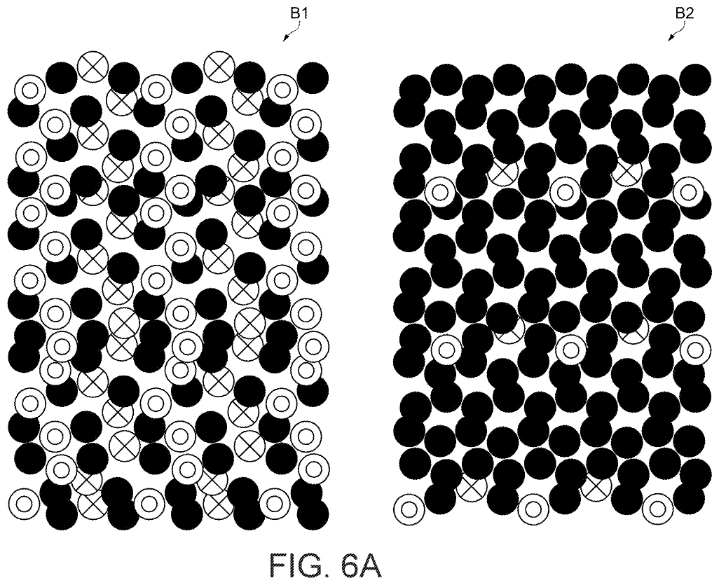

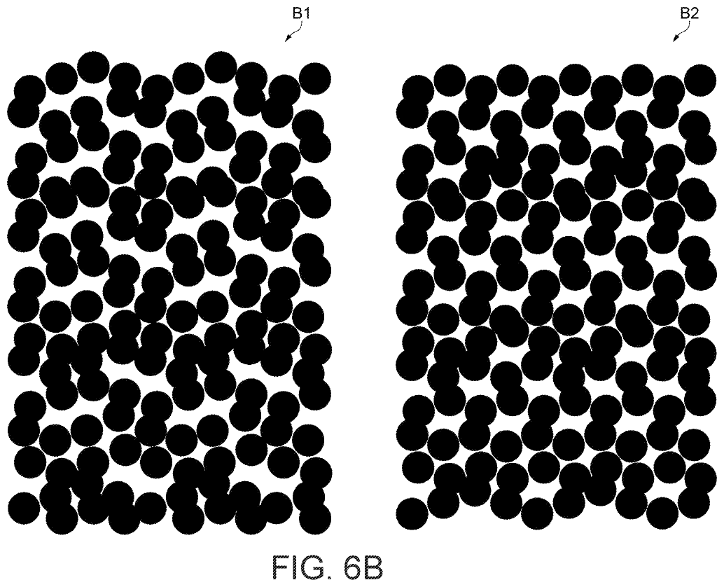

FIGS. 6A and 6B are views showing the positions of dots when the ink ejection positions are shifted in both the main scanning direction D1 and the sub-scanning direction D2, and the positions of the dots are obtained by simulation. Here, FIG. 6A is a diagram in which each dot is represented by the same mark as in FIG. 3B and FIG. 4B, and FIG. 6B is a diagram in which all dots are represented by black circle marks so that the difference in graininess can be easily understood. In both figures, the dot group indicated by B1 is a dot group formed when overlap printing in the first mode is executed, and the dot group indicated by B2 is a dot group formed when overlap printing in the second mode is executed. Such a deviation in ejection position can occur, for example, while a cut sheet as the medium 30 is transported, the medium 30 raises up when the medium 30 moves away from the nip rollers, which transport the medium 30 while pressing the medium 30 from above and below, so that the distance between the medium 30 and the print head 19 changes.

Since such deviation of the ejection position occurs only at the timing when the medium 30 moves away from the nip rollers, only about one pass is affected. However, this is greatly affected by a printing method of forming raster lines using many passes, that is, a printing method of forming raster lines using many nozzles 20. In other words, the influence increases in a printing method having a large number of overlaps or a printing method having a large number of complementary raster lines.

As shown in FIG. 6B, also in this example, overlap printing in the first mode, in which the number of the complementary raster lines is large, deteriorates graininess more than compared with overlap printing in the second mode.

In the present embodiment, overlap printing mode is switched to the first mode or to the second mode depending on the color of the ink, in order to maintain suppression of banding caused to overlap printing, while suppressing degradation in graininess caused by deviation in the ejection position. Specifically, since degradation in graininess caused by deviation in the ejection position is particularly noticeable in colors having high visibility, printing with ink of colors having relatively high visibility is performed by overlap printing in the second mode and printing with ink of colors having relatively low visibility is performed by overlap printing in the first mode. Specifically, since the visibility of achromatic ink is relatively high, printing with achromatic ink, that is, black ink ejected from the nozzle array 26K, is performed by overlap printing of the second mode. On the other hand, printing with other inks of a chromatic color, that is, cyan ink ejected from the nozzle array 26C, magenta ink ejected from the nozzle array 26M, and yellow ink ejected from the nozzle array 26Y is performed by overlap printing in the first mode.

That is, in the present embodiment, when five raster lines are formed by black ink, the control section 11 forms all of the five raster lines using the nozzles 20 included in the downstream end nozzle group N11, the nozzles 20 included in the upstream end nozzle group N12, and the nozzles 20 included in the intermediate nozzle group N13. When five raster lines are formed by inks other than black ink, the control section 11 forms one raster line using the nozzles 20 included in the downstream end nozzle group N21, the nozzles 20 included in the upstream end nozzle group N22, and the nozzles 20 included in the intermediate nozzle group N23, and forms the other four raster lines by two nozzles 20 included in the intermediate nozzle group N23.

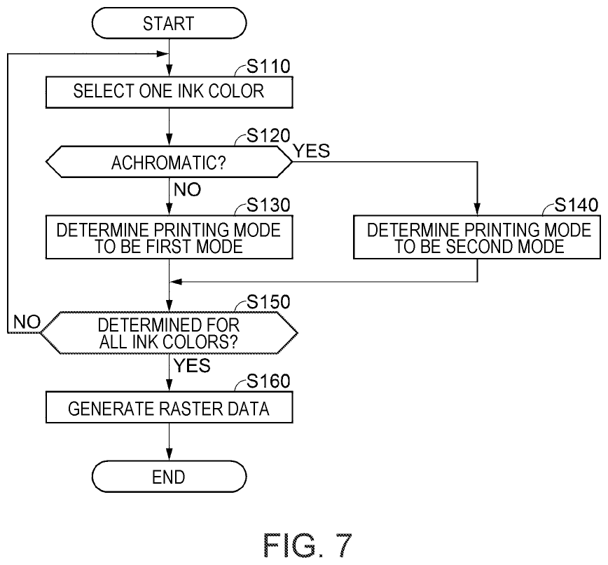

FIG. 7 is a flowchart showing a process executed by the control section 11 according to the program 12 in the present embodiment.

Note that prior to the flow shown in FIG. 7, the control section 11 converts the image data designated by the user into print data that can be printed by the printing device 10.

Specifically, the control section 11 first acquires image data representing an image to be printed. For example, the control section 11 acquires the image data that was designated through an operation by the user at the operation receiving section 14, from the storage section 15 or other memory in the printing device 10. Alternatively, the control section 11 may receive the image data via the communication IF 16.

If the acquired image data is RGB data having gradation values of red (R), green (G), and blue (B) for each pixel, the control section 11 converts the RGB data into CMYK data expressible by ink. For example, the control section 11 refers to a color conversion table or the like that defines the correspondence between RGB and CMYK, and converts the RGB gradation values to CMYK gradation values.

The control section 11 converts each tone value of CMYK obtained by the conversion into a value representing dot-on or dot-off of CMYK by halftone processing using a dither method, an error diffusion method, or the like. Dot-on means ejection of dots, and dot-off means non-ejection of dots. As a result, print data defining dot-on or dot-off of each of the CMYK inks for each pixel is generated.

When the print data is generated by halftone processing, the control section 11 executes the operations of steps S110 to S160 to determine the print mode of the overlap printing and to rasterize the print data based on the determined print mode. A rasterizing process is a process of generating, for each ink color, raster data that defines from which nozzles 20 and in what order the ink is to be ejected in each pass. Even if the print data is the same, if the printing mode of overlap printing is different, the generated raster data will be different.

First, the control section 11 selects one of the four ink colors of CMYK (step S110) and determines whether the selected ink color is achromatic, that is, is black (step S120). If the selected ink color is not achromatic, that is, if it is cyan, magenta, or yellow (step S120: NO), the control section 11 determines the printing mode of overlap printing to be the first mode (step 130). On the other hand, when the selected ink color is achromatic, that is, black (step S120: YES), the control section 11 determines the printing mode of overlap printing to be the second mode (step 140). Thereafter, the control section 11 judges whether or not the printing mode has been determined for all the ink colors (step S150), and if there is an ink color that has not yet been determined (step S150: NO), the control section 11 selects the next ink color (step S110) and repeats the above operation.

When the printing mode is determined for all the ink colors (step S150: YES), the control section 11 executes the rasterizing process described above. Specifically, the control section 11 generates raster data based on the print data and the determined print mode (step 160), and ends the flow.

When the raster data is generated by the flow described above, the control section 11 executes ejection of ink to the medium 30, that is, printing of an image, based on the generated raster data.

As described above, according to the printing device 10 of the present embodiment, the following effects can be obtained.

According to this embodiment, the printing mode is changed in accordance with the color of the ink. In other words, the number of complementary raster lines included in the predetermined number of raster lines or the number of nozzles 20 forming the raster lines is changed according to the color of the ink. Therefore, with respect to the ink of the color in which degradation of graininess is conspicuous, both banding and degradation of graininess can be suppressed by reducing the number of the nozzles 20 constituting the raster line, compared with ink of another color.

According to this embodiment, printing with black ink, which is achromatic ink, is performed in the second mode using a relatively small number of nozzles 20, and printing with ink of another color, which is chromatic ink, is performed in the first mode using a relatively large number of nozzles 20. In general, the degradation of graininess of achromatic color ink is more conspicuous than that of chromatic color ink. Therefore, by reducing the number of nozzles 20 used in printing with achromatic ink as compared with printing with chromatic ink, it is possible to make the degradation of graininess less conspicuous.

Note that in the above embodiment, the cyan ink, the magenta ink, and the yellow ink ejected by overlap printing in the first mode correspond to a first liquid, and the black ink ejected by overlap printing in the second mode corresponds to a second liquid. The nozzle arrays 26C, 26M, and 26Y correspond to a first nozzle array, and the nozzle array 26K corresponds to a second nozzle array.

The above embodiment may be modified as follows.

In the above embodiment, the printing mode of overlap printing, that is, the number of nozzles 20 forming a raster line is changed based on whether the ink is achromatic or not, but the present disclosure is not limited to this configuration. For example, the printing mode of overlap printing may be changed based on the viscosity of the ink. Generally, since ink having a high viscosity tends not to spread after being ejected onto the medium 30, the deterioration of graininess is conspicuous. For this reason, it is desirable that printing with an ink having a relatively low viscosity be performed in the first mode, and printing with an ink having a relatively high viscosity be performed in the second mode. In other words, it is desirable that the ink with which overlap printing in the second mode is performed has a higher viscosity than ink with which overlap printing in the first mode is performed.

The printing mode of the overlap printing may be changed based on the lightness of the ink in the Lab color space. In general, in the case where the color of the medium 30 is a color having a high brightness such as white, the deterioration of graininess is more conspicuous with ink having a low brightness. For this reason, it is desirable that printing with an ink having a relatively high brightness be performed in the first mode, and printing with an ink having a relatively low brightness be performed in the second mode. That is, when the lightness of the color of the medium 30 is high, it is desirable that the lightness of the ink with which overlap printing in the second mode is performed be lower than that of the ink with which overlap printing in the first mode is performed.

On the other hand, in the case where the color of the medium 30 is a color having a low brightness such as black, the deterioration of graininess is more conspicuous with ink having a high brightness. For this reason, it is desirable that printing with an ink having a relatively low brightness be performed in the first mode, and printing with an ink having a relatively high brightness be performed in the second mode. In other words, when the brightness of the color of the medium 30 is low, it is desirable that the brightness of the ink with which overlap printing in the second mode is performed be higher compared to that of the ink with which overlap printing in the first mode is performed.

In the above embodiment, the number of nozzles 20 included in the nozzle array 26, the nozzle pitch, and the amount of movement of the medium 30 in sub-scanning for each pass are not limited to the above. The amount of movement of the medium 30 in sub-scanning for each pass may not be constant over the entire region of the medium 30 and, for example, the amount of movement may be smaller at the upstream end side and at the downstream end side of the medium 30 than in the middle region.

In the above embodiment, assuming that the number of nozzles 20 included in the downstream end nozzle group N11 or in the upstream end nozzle group N12 in the first mode is m and the number of nozzles 20 included in the downstream end nozzle group N21 or the upstream end nozzle group N22 in the second mode is n, then m is 5 and n is 1. That is, when the amount of movement of the medium 30 in the sub-scanning for each pass is 5d, all five of the five continuous raster lines are complementary raster lines in the first mode, and one of the five continuous raster lines is a complementary raster line in the second mode. However, the values of m and n are not limited to the above values. When the amount of movement of the medium 30 in the sub-scanning for each pass is f·d, then the relationship of f≥m>n≥1 should be satisfied. In other words, it is sufficient that the number of complementary raster lines included in the f number of raster lines be larger in the first mode than in the second mode. In other words, it is sufficient that the total number of nozzles 20 forming the f number of raster lines or the sum of the number of overlaps in the f raster lines is larger in the first mode than in the second mode.

In the above embodiment, an example was shown in which f=m (=5), assuming that the number of nozzles 20 included in the downstream end nozzle group N11 or the upstream end nozzle group N12 in the first mode is m and that the movement amount of the medium 30 in the sub-scanning for each pass is f·d. However, f>m is acceptable. In this case, when forming the f number of continuous raster lines, the control section 11 sets m raster lines as complementary raster lines, and the (f-m) raster lines may be formed by a plurality of nozzles 20 included in the intermediate nozzle group N13.

Although complementary raster lines are formed by three nozzles 20 in the above embodiment, the number of nozzles 20 forming complementary raster lines is not limited to three, and may be three or more. Although the raster lines other than the complementary raster lines are formed by two nozzles 20 in the above embodiment, the number of nozzles 20 forming the raster lines other than the complementary raster lines is not limited to two, and may be two or more.

What is claimed is:

1. A printing device for printing on a medium, the printing device comprising:
a print head configured to form a plurality of dots on the medium by ejecting a first liquid and a second liquid, the print head including a first nozzle array in which a plurality of nozzles for ejecting the first liquid to the medium are arranged along a first direction and a second nozzle array in which a plurality of nozzles for ejecting the second liquid, which is different in color from the first liquid, to the medium are arranged along the first direction and
a control section configured to execute printing by repeating main scanning in which the first liquid and the second liquid are ejected from the print head while a relative position of the print head with respect to the medium is changed in a second direction that intersects the first direction and sub-scanning in which the relative position of the print head with respect to the medium is changed by f dots along the first direction, f being a natural number, wherein
the plurality of nozzles included in the first nozzle array are dividable into a first nozzle group including m nozzles located on one end side in the first direction, m being a natural number satisfying f≥m>1, a second nozzle group including m nozzles located on an other end side in the first direction, and a third nozzle group including a plurality of nozzles located in between the first nozzle group and the second nozzle group,
the plurality of nozzles included in the second nozzle array are dividable into a fourth nozzle group including n nozzles located on the one end side in the first direction, wherein n is a natural number satisfying m>n≥1, a fifth nozzle group including n nozzles located on the other end side in the first direction, and a sixth nozzle group including a plurality of nozzles located in between the fourth nozzle group and the fifth nozzle group, and
the control section is configured to
when f consecutive raster lines are to be formed by the first liquid, form m raster lines by the nozzles included in the first nozzle group, by the nozzles included in the second nozzle group, and by the nozzles included in the third nozzle group, and form other f-m raster lines by two or more nozzles included in the third nozzle group and
when f consecutive raster lines are to be formed by the second liquid, form n raster lines by the nozzles included in the fourth nozzle group, by the nozzles included in the fifth nozzle group, and by the nozzles included in the sixth nozzle group, and form other f-n raster lines by two or more nozzles included in the sixth nozzle group.

2. The printing device according to claim 1, wherein
the first liquid is a chromatic liquid and the second liquid is an achromatic liquid.

3. The printing device according to claim 2, wherein
the second liquid has a viscosity higher than that of the first liquid.

4. The printing device according to claim 1, wherein
the second liquid is a color having a lower brightness in the Lab color space than does the first liquid.

5. A printing method using
a print head configured to form a plurality of dots on a medium by ejecting a first liquid and a second liquid, the print head including a first nozzle array in which a plurality of nozzles for ejecting a first liquid to a medium are arranged along a first direction and a second nozzle array in which a plurality of nozzles for ejecting the second liquid, which is different in color from the first liquid, to the medium are arranged along the first direction,
the printing method comprising:
executing printing on the medium by repeating main scanning of ejecting the first liquid and the second liquid from the print head while changing a relative position of the print head with respect to the medium along a second direction, which intersects the first direction and sub-scanning for changing a relative position of the print head with respect to the medium along the first direction by f dots, f being a natural number,
the plurality of nozzles included in the first nozzle array are dividable into a first nozzle group including m nozzles located on one end side in the first direction, m being a natural number satisfying f≥m>1, a second nozzle group including m nozzles located on an other end side in the first direction, and a third nozzle group including a plurality of nozzles located in between the first nozzle group and the second nozzle group,
the plurality of nozzles included in the second nozzle array are dividable into a fourth nozzle group including n nozzles located on the one end side in the first direction, wherein n is a natural number satisfying m>n≥1, a fifth nozzle group including n nozzles located on the other end side in the first direction, and a sixth nozzle group including a plurality of nozzles located in between the fourth nozzle group and the fifth nozzle group,
when f consecutive raster lines are to be formed by the first liquid, forming m raster lines by the nozzles included in the first nozzle group, by the nozzles included in the second nozzle group, and by the nozzles included in the third nozzle group, and forming other f-m raster lines by two or more nozzles included in the third nozzle group, and
when f consecutive raster lines are to be formed by the second liquid, forming n raster lines by the nozzles included in the fourth nozzle group, by the nozzles included in the fifth nozzle group, and by the nozzles included in the sixth nozzle group, and forming other f-n raster lines by two or more nozzles included in the sixth nozzle group.
